(19) United States
(12) Patent Application Publication
(10) Pub. No.: US 2007/0228826 A1
(43) Pub. Date: Oct. 4, 2007

(54) Modular, extensible electrical and communication systems, methods, and devices

(76) Inventors: Patrick D. Jordan, Austin, TX (US); Walton L. Fehr, Mundelein, IL (US); Michael J. McGrath, Livonia, MI (US); Donald J. Remboski, Akron, OH (US)

Correspondence Address: MOTOROLA, INC., 1303 EAST ALGONQUIN ROAD, IL01/3RD, SCHAUMBURG, IL, 60196, US

(21) Appl. No.: 11/394,944

(22) Filed: Mar. 31, 2006

(51) Int. Cl. B60L 1/00

(52) U.S. Cl. 307/10.1

(57) ABSTRACT

Disclosed herein are embodiments of a flexible, extensible, modular approach to electrical and communication system architecture in a vehicle. In accordance with certain embodiments of the present invention, standardized, high-volume housings and components referred to as Plug-In Modules (PIMs) are used in vehicle electrical centers. By carefully designing standardized PIMs, the same PIMs can be used (in differing quantities) on any vehicle in the range of vehicles manufactured. Furthermore, the same PIMs can even be used across different vehicle manufacturers. The use of standard modules and standard housings allows for very high-volume production, thereby dramatically reducing the cost of the electrical centers. At the same time, there can be virtually zero giveaway in vehicles with lower option content. Methods of power and signal distribution using the disclosed electrical and communication system are provided. Methods of manufacturing the electrical and communication system are further provided.

### FIELD OF THE INVENTION

The present invention is generally related to electrical systems, and more particularly, to vehicle electrical and communication systems, methods, and devices.

### BACKGROUND

Without limiting the scope of the present invention, its background is described in connection with electrical and communication systems which may be found particularly useful in vehicles. Vehicles such as automobiles typically include one or more systems for controlling operation of various electrical loads during operation of the vehicle. Vehicles also typically include one or more systems for vehicle data communications.

Body electrical centers (BECs) typically contain a large number of fuses and relays to distribute power to the various loads on the vehicle. In some cases, such relays are controlled by wires from the switches on the dash or from a body control module (BCM). In other cases, the BEC includes a microcontroller, and the BCM sends commands to the BEC via a serial communication bus (e.g., a controller area network (CAN) bus). The BEC then executes the commands by turning on the relay or the semiconductor switch for the desired load. Such BECs typically include a printed circuit board (PCB) to mount the microcontroller and other electronic components. A vehicle can include multiple BECs, such as a rear BEC, under hood BEC and instrument panel BEC.

In manufacturing vehicles, various options and features may be added at the factory or afterward, e.g., at the dealership. A few examples of such options and features include without limitation power windows, power door locks, sun roofs, navigation systems, compact disc (CD) players, seat warmers, fog lights, etc. The complexity and cost of vehicle electrical and communication systems increase as new features and options become available. Moreover, auxiliary devices requiring power, such as cellular telephones, media players, and personal digital assistants (PDAs), are being increasingly used in vehicles.

Vehicle manufacturers can design all their BECs to accommodate the highest possible feature content, but this practice potentially gives away some of the capability of the unit on a lower content vehicle. While this practice can achieve greater volume, which in turn can lower the overall cost of the unit, it increases the cost of the lower end vehicle (e.g., the entry-level model), which is normally the most cost-sensitive, and which can reduce overall sales. Alternatively, manufacturers can design BECs for a specific vehicle and a specific feature content and achieve a low-cost, customized solution. This avoids the issue of potential giveaway by customizing the unit to the vehicle, but reduces the overall volume, thereby increasing the unit cost. Neither solution is optimal, and vehicle manufacturers continue to struggle with optimizing the options offered on any model and balance that against the capability of the electrical centers. This typically results in a proliferation of BEC designs with less than optimal cost.

A need has therefore arisen to provide improved electrical and communication systems, methods, and devices that overcome the deficiencies, or at least minimize the problems, in the prior art.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 depicts a top plan view of an exemplary electrical center in accordance with one embodiment of the present invention;

FIG. 2 depicts a top view of an exemplary electrical and communication system in accordance with one embodiment of the present invention;

FIG. 3 depicts a side elevational view of an electrical system in accordance with one embodiment of the present invention;

FIG. 4 depicts a top plan view of a customizable harness connector in accordance with one embodiment of the present invention;

FIG. 5 depicts an exploded view of a plug-in-module (PIM) and a harness connector in accordance with one embodiment of the present invention;

FIG. 6 depicts a top plan view of an exemplary electrical and communication system in accordance with an alternative embodiment of the present invention;

FIG. 7 depicts an exploded view of a PIM and a harness connector in accordance with the alternative embodiment of the present invention; and

FIG. 8 depicts a side elevational view of a customizable harness connector in accordance with the alternative embodiment of the present invention.

### DETAILED DESCRIPTION OF THE INVENTION

Embodiments of the present invention provide a flexible, extensible, modular approach to electrical and communication system architecture that overcomes the limitations of the prior art. In accordance with certain embodiments of the present invention, standardized, high-volume housings and components referred to as PIMs are used in electrical centers. By carefully designing standardized PIMs, the same PIMs can be used (in differing quantities) on any vehicle in the range of vehicles manufactured. Indeed, the same PIMs can even be used across different vehicle manufacturers. The use of standard modules and standard housings allows for very high-volume production, thereby dramatically reducing the cost of the electrical centers. At the same time, there can be virtually zero giveaway of functionality in vehicles with lower option content.

In accordance with certain embodiments of the present invention, the PIMs are designed to have a standardized size and/or shape which may be characterized, for example, by a fixed length in one dimension, and a variable length in another dimension. The PIMs are configured to be plugged into standardized slots or sockets of a backplane in the electrical center housing. The backplane provides various common signals to the PIMs, such as a battery feed, ground, ignition power, auxiliary power, data bus, and various communication interfaces. A PIM may include a PCB and circuitry for performing any of a myriad of functions. Furthermore, a PIM may include circuitry for performing a combination of different functions. In accordance with certain embodiments of the present invention, an electrical center may be configured to house a PIM comprising a microcontroller programmed with controlling software for sending commands to various other PIMs. Customized software may be downloaded onto the microcontroller at installation.

In accordance with certain embodiments of the present invention, an electrical and communication system is provided which comprises a backplane having a plurality of substantially uniform socket configurations. The system includes a plurality of functional modules, each of which comprises a pin arrangement configured for insertion into one or more of the socket configurations. One or more of the plurality of functional modules is configured to distribute power to a load in a vehicle. The backplane provides a data bus connection and a battery connection to the functional modules. The system further comprises a housing for protecting the backplane.

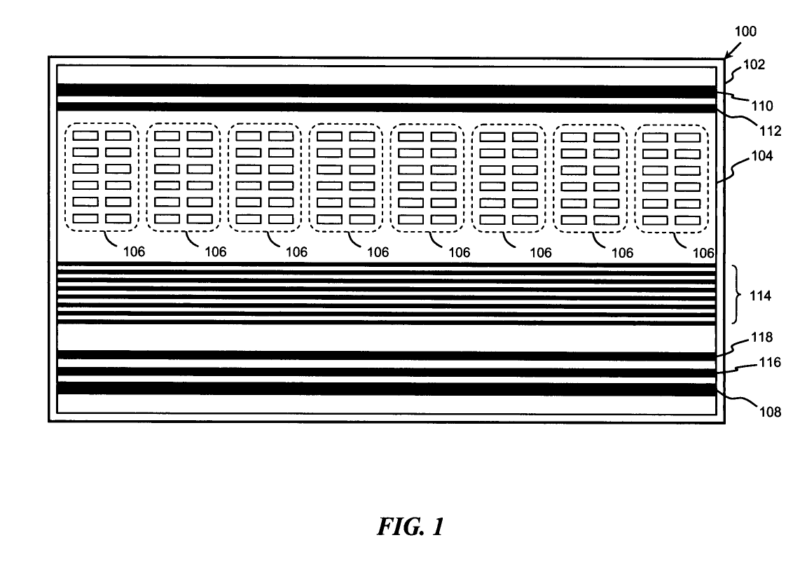

Understanding of various embodiments of the present invention will be facilitated by reference to FIG. 1, which depicts a top view of an exemplary electrical center 100 in accordance with one embodiment of the present invention. The electrical center 100 may comprise, for example, an under hood electrical center used in connection with a vehicle, such as an automobile. In addition, other types of vehicles may be used such as a truck, bus, recreational vehicle (RV), subway, train, boat, plane, or other type of means of transportation.

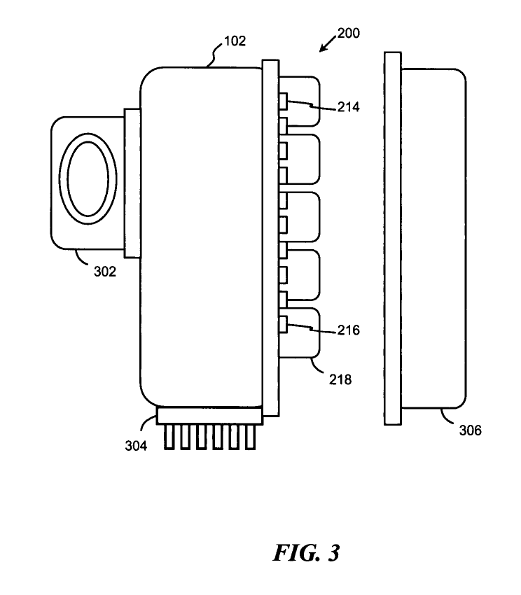

The electrical center 100 includes a housing 102 (e.g., a box) designed to receive a number of PIMs, as described further below. The housing 102 is preferably designed to be standardized in order to be used in multiple vehicles. The housing 102 protects a backplane 104 to which the PIMs are connected. The housing 102 may be covered by a protective lid, such as the lid 306 shown in FIG. 3.

The PIMs can be plugged into any of a plurality of substantially uniform socket configurations 106. The substantial uniformity of the socket configurations 106 allows flexibility and interchangeability in the system architecture. The spacing between adjacent socket configurations 106 is not necessarily uniform; however, at least some of the socket configurations 106 may be spaced at regular intervals such that the backplane can accommodate PIMs of varying widths, such as a single-wide PIM, a double-wide PIM, a triple-wide PIM, etc., as well as a combination thereof.

The backplane 104 is extensible to carry a different number of PIMs. For example, the backplane 104 may be provided in a range of sizes (e.g., 6-PIM, 8-PIM, 10-PIM, and 12-PIM, etc.) in order to accommodate a range of vehicles and options. In the present example, the backplane 104 shown in FIG. 1 can accommodate up to 8 PIMs.

The backplane 104 provides various common signals to the PIMs. For example, a battery feed 108 and a connection to ground 110 are provided. Communication between or among PIMs is provided by way of a data bus 112, such as, for example, a serial peripheral interface (SPI), or a serial communications interface (SCI), or a local interconnect network (LIN), or other suitable interface. The backplane 104 may optionally provide connections to provide ignition enabled power via line 116, auxiliary power via line 118, or other power to other modules, and signal capability between or among PIMs. Wireless transmission of signals to and from the PIMs may also be provided. External connection to the PIMs may be provided via a customizable harness connector on one or more edges of the housing 102, as described further below.

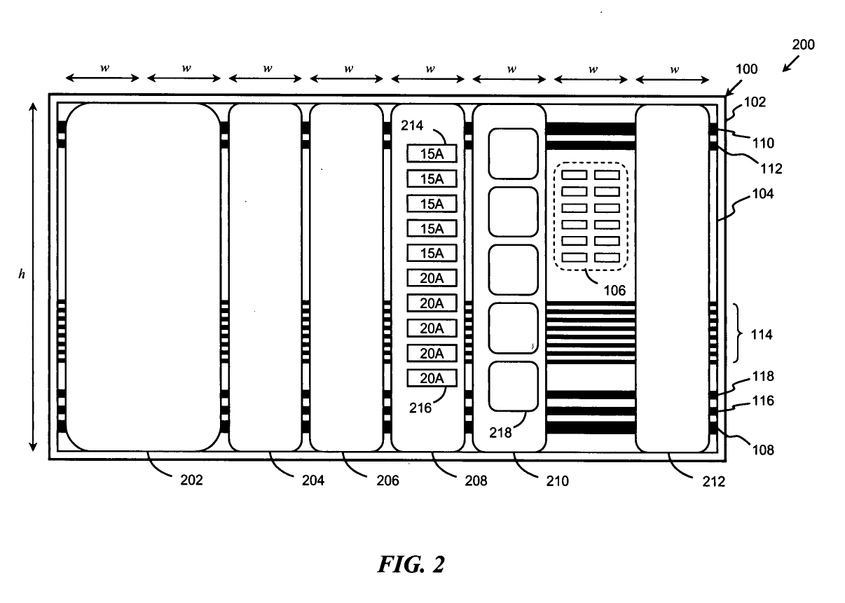

Reference is now made to FIG. 2, which depicts an electrical and communication system 200 having one of many possible configurations of PIMs as used in connection with the electrical center 100 of FIG. 1. The example configuration of FIG. 2 depicts PIMs 202, 204, 206, 208, 210, and 212 installed into the backplane 104 of the electrical center 100, and an unoccupied section of the backplane 104 that is unused and available to receive another PIM. The number of PIMs actually installed in a given electrical center will vary depending on the vehicle make and model and the needs of the vehicle. The PIMs are interchangeable and can be easily connected or disconnected from the electrical center 100.

The PIMs may be designed to be of a standardized size in at least one dimension, in order to achieve flexibility and modularity. For example, each PIM may be of a fixed height h and a standard width w, or a multiple of w, wherein w represents the width of a section occupied by the narrowest PIM. As shown in FIG. 2, PIMs 204, 206, 208, 210, and 212 are single-width PIMs, and PIM 202 is a double-width PIM. The standardized size and/or shape further allows the PIMs to be generally interchangeable as units.

A PIM generally comprises a functional sub-assembly of electrical or electronic components. A representative PIM may comprise a PCB with components for performing any of a variety of functions. For example, PIM 202 may comprise a processor PIM including a microcontroller, a communications interface to the vehicle (e.g., CAN), and a communications interface to the other PIMs (e.g., LIN). Controlling software is provided on the microcontroller. The software may be downloaded at the point of installation in order to achieve customization.

The processor PIM can operate to control other PIMs. Commands sent from another module in the vehicle over the vehicle communication bus (e.g., CAN) are received and executed by the processor PIM. The processor PIM sends data via the data bus 112 to the PIM that is associated with the requested function. For example, a module such as the BCM may request the vehicle headlights be turned on. The processor PIM sends a command over the data bus 112 to the PIM that contains the headlight output device (e.g., relay or high-side driver). In addition, diagnostic information can be received by the processor PIM via the data bus 112 and communicated back to the BCM. There may be one or more different processor PIMs (e.g., 8 bit or 16 bit, etc.) available depending on the complexity and processing power required for the range of vehicles being covered. The particular microcontroller may be selected according to the needs of the vehicle.

As another example, PIM 204 may comprise several general purpose high-side drivers which are addressable over the communications backplane. The high-side drivers might be used, for example, to drive headlights, or the horn, or the windshield wipers, etc. PIM 206 may comprise a combination of high-side drivers for switching the vehicle battery to various loads and low-side drivers for switching ground to various loads. PIM 208 may comprise a number of different fuses, such as a combination of 15 Amp fuses 214 and 20 Amp fuses 216 as depicted in FIG. 2. PIM 210 may comprise a number of relays 218 (i.e., electromechanical switches). PIM 212 may comprise a module of pass through connectors to provide a straightforward connection from one pin to another. Certain PIMs such as those with fuses or pass through connectors may not need to communicate with the Processor PIM.

Additional examples of PIMs that may be used with the electrical center 100 include input PIMs for collecting inputs, monitoring various switches, and sending information to the processor PIM. Gateway PIMs may also be provided for sending and receiving data to and from separate communication networks. Yet another example of a type of PIM that may be used with the electrical center is a remote keyless entry (RKE) receiver for receiving a signal from an RKE transmitter which may be included in a key fob.

It will be appreciated by those of skill in the art that the foregoing examples of PIMs are provided as illustrative examples only and are not to be considered as exhaustive or limiting. Embodiments of the present invention may be practiced with PIMs that implement any of a myriad of types of functions.

Furthermore, a PIM may provide for a combination of functions such as any of those described above. The vehicle manufacturer is given the ability to choose the best combination of functions for a range of vehicle options. In doing so, the volume produced of any given PIM may be maximized due to the fact that the PIM can be used across the full range of vehicles. Advantageously, a vehicle manufacturer can mass-produce various desired PIMs which can be later installed to customize the unit to the specific vehicle requirements and option content.

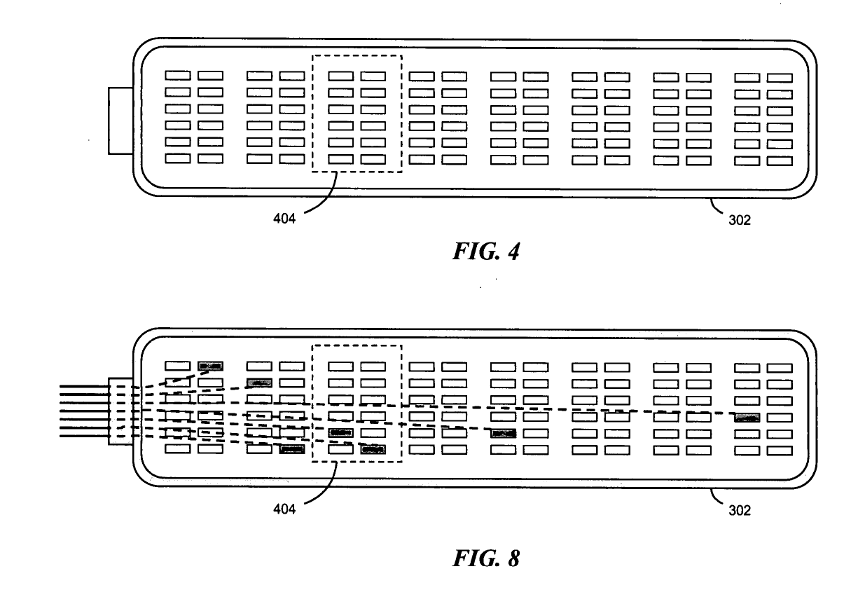

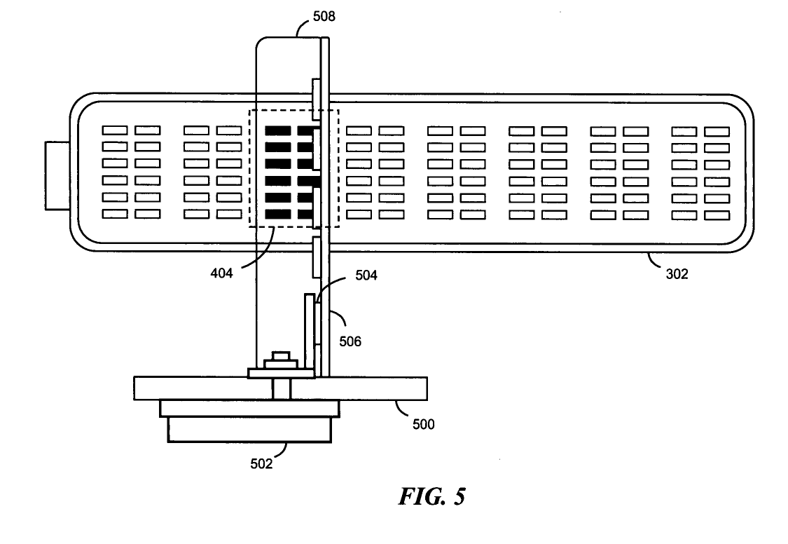

Reference is now made to FIG. 3, which depicts a side elevational view of an electrical system in accordance with one embodiment of the present invention. The electrical center 100 may include a customizable harness connector 302 which allows the PIMs to interface to the vehicle's wire harness. The PIMs have a standard arrangement of pins, and the harness connector 302 is selectively populated to mate to those pins. The harness connections may connect to shorts on the PIM, in the case of a pass through, or to fuses to pick up power for other parts of the vehicle. A top plan view of the customizable harness connector 302 is depicted in FIG. 4. An exploded view of a PIM 508 with the harness connector 302 is depicted in FIG. 5. The PIMs have a standard arrangement of pins, and the harness connector 302 is selectively populated to mate to those pins, e.g., at connections 404.

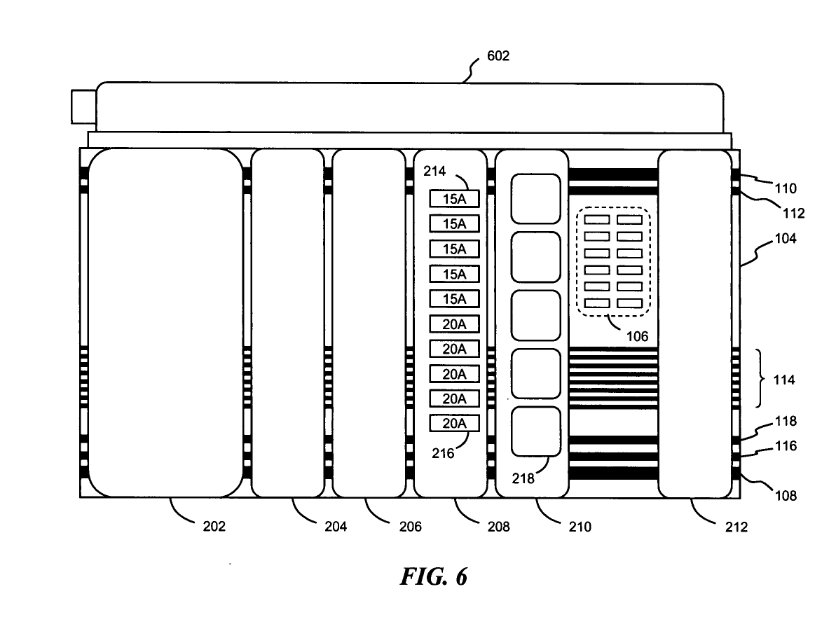

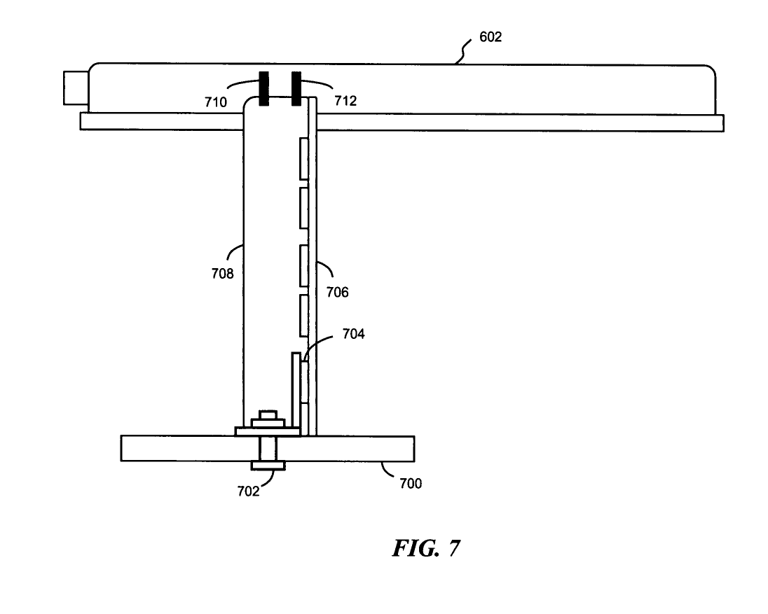

An alternative configuration of the electrical system with a vertically mounted customizable harness connector 602 in accordance with another embodiment of the present invention is depicted in FIG. 6. The electrical system may comprise, in this example, a rear electrical center. In this example, the electrical center 100 is intended to be mounted vertically on the sidewall. Accordingly, the harness connector 602 is mounted on the top. The PIMs have a standard arrangement of pins, and the harness connector 602 is selectively populated to mate to those pins at connections 710 and 712 as shown in FIG. 7.

In order for the vehicle wire harness to connect to the appropriate pins on the respective PIM, a customizable harness connector 302 is used, as illustrated in FIG. 8. The wires from the vehicle harness are routed to the appropriate pin and populated to mate to the driver for that function.

Some of the PIMs may dissipate a significant amount of power, and provision may therefore be made for adequate heat sinking. Accordingly, the electrical center 100 may optionally include a heat sink 304, as shown in FIG. 3. The heat sink 304 is connected to the outer case of the housing 102 for additional dissipation. The heat sink 304 is further connected to the high power components in a given PIM. For example, FIG. 5 illustrates a heat sink 502 connected to a housing 500 and to an electronic component 504 on a PCB 506 of PIM 508. As another example, FIG. 7 illustrates a heat sink 702 connected to a housing 700 and to an electronic component 704 on a PCB 706 of PIM 708. Depending on the level of power to be dissipated, the vertical orientation of the PIM may change, as illustrated in FIG. 7.

In accordance with certain embodiments of the present invention, a method of power and signal distribution is provided. A standardized backplane having substantially uniform socket configurations is selected. A plurality of PIMs are selected from a set of interchangeable PIMs, which may provide for a wide variety of functionality. The PIMs are connected to the backplane and are thereby connected to a data bus connection and a battery connection. One of the PIMs may comprise a microcontroller, which can be programmed to control one or more of the other PIMs. The microcontroller sends signals to one or more of the other PIMs via the data bus connection, thereby instructing a designated PIM to deliver power to a specified load. The microcontroller advantageously enables the real-time control of power and signal distribution.

In accordance with additional embodiments of the present invention, a method of manufacturing an electrical and communication system is provided. The method of manufacture includes selecting a standardized housing for a backplane, which has a plurality of substantially uniform socket configurations. The method further includes selecting the desired PIMs from a set of pre-assembled PIMs, which may provide for a wide variety of functionality. The PIMs are connected to the backplane, which provides a data bus connection and a battery connection to the PIMs. One of the PIMs may comprise a microcontroller, which can be programmed to control one or more of the other PIMs. The electrical and communication system can be customized by selecting a different arrangement of plug-in modules based on the particular vehicle options or requirements.

Thus, it can be seen that the teachings of the present disclosure provide numerous advantages over the prior art. For instance, the modular architecture allows for scalability, in that a fixed housing can accommodate a variable number of PIMs. The number of PIMs installed into a given electrical center can be scaled depending on the features and requirements of the vehicle. In addition, the modular architecture provides added flexibility in that the housing or box may be standard across all vehicles of a particular model or multiple models, but varying types and quantities of PIMs may be used and interchanged to achieve a desired level of features and capability.

The standardized PIMs and standardized boxes described herein can be mass-produced and pre-assembled. This approach allows the systems to be manufactured at high volumes, which advantageously lowers the cost of manufacture. This in turn can lower the price of the vehicle, which can result in increased revenue. Furthermore, this is of great benefit to vehicle manufacturers who would ordinarily need to subject each of their custom-made boxes and custom-made circuit boards to a myriad of tests and qualifications. The pre-manufactured, pre-assembled PIMs and boxes of the present disclosure, on the other hand, have already been tested and qualified, which advantageously reduces the time, cost, and effort spent by manufacturers in performing the necessary tests.

Thus, unlike the solutions of the prior art, the modular systems described herein advantageously provide solutions for high-end vehicles with premium options and features, without equipping basic, low-end vehicles with capability that will go unused. Indeed, the systems and methods described herein allow for customization of the electrical system without wasting resources.

It should be understood that the inventive concepts disclosed herein are capable of many modifications, combinations, and sub-combinations. To the extent such permutations fall within the scope of the appended claims and their equivalents, they are intended to be covered by this patent.

What is claimed is:

1. A vehicular electrical and communication system comprising:
a backplane having a plurality of substantially uniform socket configurations;
a plurality of functional modules, each of which comprises a pin arrangement configured for insertion into one or more of the socket configurations; and
a housing for protecting the backplane;
wherein one or more of the plurality of functional modules is configured to distribute power to a load in a vehicle;
wherein the backplane provides a data bus connection to the plurality of functional modules; and
wherein the backplane provides a battery connection to the plurality of functional modules.

2. The vehicular electrical and communication system of claim 1, wherein the backplane provides an auxiliary power connection to the plurality of functional modules.

3. The vehicular electrical and communication system of claim 1, wherein the backplane provides an ignition power connection to the plurality of functional modules.

4. The vehicular electrical and communication system of claim 1, wherein the backplane provides a ground connection to the plurality of functional modules.

5. The vehicular electrical and communication system of claim 1, wherein one of the plurality of functional modules comprises one or more low-side drivers coupled to the ground connection.

6. The vehicular electrical and communication system of claim 1, wherein one of the plurality of functional modules comprises one or more high-side drivers coupled to the battery connection.

7. The vehicular electrical and communication system of claim 1, wherein one of the plurality of functional modules comprises a microcontroller coupled to the data bus connection, wherein the microcontroller is programmed to send control signals to one or more of the other functional modules via the data bus.

8. The vehicular electrical and communication system of claim 1, wherein one of the plurality of functional modules comprises one or more relays.

9. The vehicular electrical and communication system of claim 1, wherein one of the plurality of functional modules comprises one or more fuses.

10. The vehicular electrical and communication system of claim 1, wherein one of the plurality of functional modules comprises electronic components for performing a combination of functions.

11. The vehicular electrical and communication system of claim 1, wherein each of the plurality of functional modules is characterized by a substantially uniform length in at least one dimension.

12. The vehicular electrical and communication system of claim 1, wherein each of the plurality of functional modules is characterized by a substantially uniform size.

13. The vehicular electrical and communication system of claim 1, further comprising a harness connector coupled to one or more of the plurality of functional modules.

14. The vehicular electrical and communication system of claim 1, further comprising a heat sink coupled to a component of one or more of the plurality of functional modules.

15. A method of power and signal distribution in a vehicle, the method comprising:
providing a plurality of functional modules, each of which is plugged into one or more of a plurality of substantially uniform socket configurations of a backplane housed in the vehicle;
providing, from the backplane, a data bus connection to the plurality of functional modules;
providing, from the backplane, a battery connection to the plurality of functional modules;
wherein one of the plurality of functional modules comprises a microcontroller, programming the microcontroller to control one or more of the other functional modules;
sending a signal from the microcontroller to one or more of the other functional modules via the data bus connection, wherein the signal comprises an instruction for delivering power to a specified load; and
delivering power to the specified load.

16. The method of claim 15, wherein each of the plurality of functional modules is characterized by a substantially uniform length in at least one dimension.

17. The method of claim 15, wherein each of the plurality of functional modules is characterized by a substantially uniform size.

18. A method of manufacturing a vehicle electrical and communication system, the method comprising:
selecting a backplane having a plurality of substantially uniform socket configurations;
selecting a plurality of plug-in modules from a set of pre-assembled plug-in modules, each of which comprises a pin arrangement configured for insertion into one or more of the socket configurations;
connecting the plurality of plug-in modules to the backplane;
providing, from the backplane, a data bus connection to the plug-in modules;
providing, from the backplane, a battery connection to the plug-in modules; and
wherein one of the plug-in modules comprises a microcontroller, programming the microcontroller to control one or more of the other plug-in modules.

19. The method of claim 18 further comprising:
customizing the electrical and communication system by selecting a different plurality of plug-in modules to be used with the selected backplane, based on a selection of vehicle options.

20. The method of claim 18, wherein each of the plug-in modules is characterized by a substantially uniform length in at least one dimension.
